(19) United States
(12) Patent Application Publication
(10) Pub. No.: US 2002/0164042 A1
(43) Pub. Date: Nov. 7, 2002

(54) Procedure for setting a hearing aid, and hearing aid

(76) Inventor: Andi Vonlanthen, Remetschwil (CH)

Correspondence Address: PEARNE & GORDON LLP, 526 SUPERIOR AVENUE EAST, SUITE 1200, CLEVELAND, OH, 44114-1484, US

(21) Appl. No.: 10/186,431

(22) Filed: Jul. 1, 2002

Related U.S. Application Data
(63) Continuation of application No. 09/431,689, filed on Nov. 1, 1999.

(30) Foreign Application Priority Data
Oct. 14, 1999 (US) PCT/CH99/00486

(51) Int. Cl. H04R 25/00

(52) U.S. Cl. 381/313; 381/312

(57) ABSTRACT

An in-the-ear hearing aid having multiple directional microphones connected to a signal processing unit. The connection of the microphones can be reversed by a selector switch to selectively switch the hearing aid between a left-ear configuration and a right-ear configuration.

This invention relates to a procedure for adaptively setting a hearing aid as described in claim 1, a hearing aid as specified in claim 3, and a production process as per claim 5.

The configuration of the outer capsule of hearing aids, and especially of in-the-ear hearing aids, in many cases does not take into consideration whether the hearing aid concerned is to be worn in the left or in the right ear.

It is thus entirely possible to manufacture uniform hearing aids regardless of whether they are to be used on the left or the right ear.

However, if the hearing aid in question incorporates two or more microphones, for instance in order to establish for the hearing-aid signal processing unit a particular reception pattern relative to the direction of the impinging sound wave, these microphones must be placed on or in the ear in a specific position in relation to the head; for example, for frontally received audio signals a microphone must point forward, whether it is worn on the left or on the right ear.

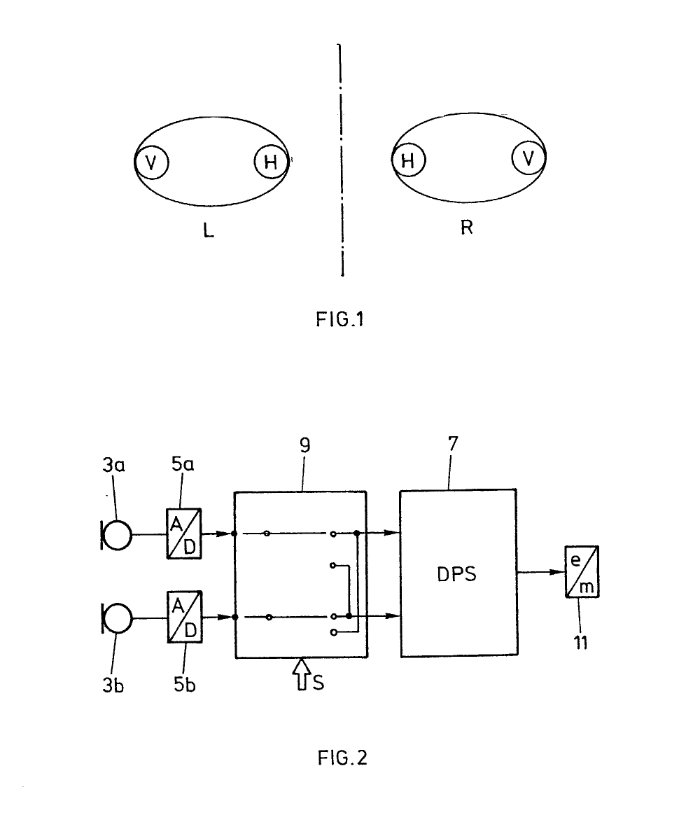

It follows that for basically uniform hearing aids, it is necessary after all to produce and handle two variations, one for the left ear and one for the right ear. This requirement is illustrated in FIG. 1 which is a schematic top view of two in-the-ear hearing aids, one for the left ear L, the other for the right ear R. As can be seen, the microphone V which serves to process audio signals received from the front and the microphone H which processes audiosignals received from behind are positioned in the otherwise uniform hearing aid in mirror-image fashion.

It goes without saying that the resulting need to produce hearing-aid sets with different microphone configurations, respectively for left-ear devices L and right-ear devices R as shown in FIG. 1, constitutes a significant drawback.

This invention is intended to solve that problem, the solution consisting in the procedure first mentioned and offering the characteristic features per claim 1, the hearing aid according to this invention as specified in claim 3, and the production method according to this invention as outlined in claim 5.

The basic concept employed in the hearing aid involves directional switchability of the signal-processing microphones. Accordingly, only one hearing-aid configuration need be manufactured and, preferably, it is not until an individual is fitted with a hearing aid that the desired setting between the respective microphone of the signal processing unit and, ultimately, the integrated output converter of the hearing aid, is selected by means of the appropriate switch position.

FIG. 2 is a schematic illustration of an example of a manufacturable hearing aid according to this invention and of the implementation of the adaptation procedure as provided for by this invention. As indicated in FIG. 2, the hearing aid according to this invention incorporates at least two microphones 3a and 3b each of which connects to an analog/digital converter 5a, 5b. According to this invention, a selector switch assembly 9 with a control input S is interpositioned between the digital outputs of the analog/digital converters 5a and 5b, respectively, and the inputs of a signal processing unit 7. The switch assembly 9 permits reversal of the output of the microphones 3a and 3b, respectively, relative to the inputs of the signal processing unit 7 which in turn inverts the signal for the electromechanical output converter 11 of the hearing aid. This makes it possible to produce identical hearing aids, and especially in-the-ear type hearing aids, with the adaptation preferably performed when the hearing aid is fitted, by setting the switch 9 so as to select forward or rearward reception of the microphone 3a or 3b and making the appropriate connection with the signal processing unit 7. The connection to the control input S of the switch assembly 9 may be hard-wired or wireless, depending on the technology employed in the design of the product.

1. Procedure for the adaptive left-ear/right-ear setting of a hearing aid incorporating at least two microphones which by way of a signal processing unit are operationally connected to at least one output converter of the hearing aid, characterized in that the functional directionality of the microphones relative to the output converter is switch-selected on the finished hearing-aid product.

2. Procedure as in claim 1, characterized in that the switch setting of the microphones is selected at the time the individual wearer is fitted with the hearing aid.

3. Hearing aid with at least two microphones the outputs of which are operationally connected via a signal processing unit to at least one output converter of the hearing aid, characterized by the interpolation between the two microphone outputs and the output-converter input of a controllable switching unit which permits the commutation of the functional directionality of the microphone outputs relative to the output converter.

4. Hearing aid as in claim 3, with an analog/digital converter respectively connected to each microphone and a digital signal processing unit connected in series with the said analog/digital converters, characterized in that the switch assembly is interconnected between the digital outputs of the analog/digital converters and the inputs of the signal processing unit.

5. Process for the manufacture of hearing aids for left-ear and right-ear use incorporating at least two microphones as well as a signal processing unit connected to the microphone outputs, characterized in that the hearing aids are produced with an identical configuration while permitting controlled directional switching between the microphones and the signal processing unit.
